(19) United States
(12) Patent Application Publication
(10) Pub. No.: US 2009/0108134 A1
(43) Pub. Date: Apr. 30, 2009

(54) ICING PROTECTION SYSTEM AND METHOD FOR ENHANCING HEAT TRANSFER

(75) Inventors: Joseph Albert Thodiyil, Fairfield, OH (US); Daniel Jean-Louis Laborie, West Chester, OH (US); Andrew Jay Skoog, West Chester, OH (US); Thomas John Tomlinson, West Chester, OH (US)

Correspondence Address: ADAMS INTELLECTUAL PROPERTY LAW, P.A., Suite 2350 Charlotte Plaza, 201 South College Street, CHARLOTTE, NC, 28244, US

(73) Assignee: GENERAL ELECTRIC COMPANY, Schenectady, NY (US)

(21) Appl. No.: 11/923,753

(22) Filed: Oct. 25, 2007

(51) Int. Cl. B64D 15/02; B64D 15/04

(52) U.S. Cl. 244/134 B; 244/134 R

(57) ABSTRACT

An icing protection system and method for enhancing heat transfer includes a substrate having an inner wall, an outer wall and a thickness separating the inner wall and the outer wall. A metallic layer deposited on the inner wall of the substrate by an electric arc thermal spray deposition process using at least one metallic wire has a thickness between about 0.203 mm (0.008 inches) and about 0.432 mm (0.017 inches), a surface roughness greater than about 12.7 microns (500 micro-inches) Ra, and a heat transfer augmentation of at least about 1.1. The metallic layer is formed on the inner wall from an M-Cr—Al alloy where M is selected from Fe, Co and Ni. The metallic layer defines a plurality of turbulators that act as micro-fins to enhance heat transfer from a heated gas in flow communication with the metallic layer through the substrate to prevent the formation of ice on the outer wall.

### BACKGROUND OF THE INVENTION

This subject matter of this application relates generally to icing protection for aircraft structures, and more particularly, to an icing protection system and method for enhancing heat transfer in aircraft structures that are susceptible to icing.

The formation of ice on aircraft structures, for example engine inlets, wings, control surfaces, propellers, booster inlet vanes, inlet frames, etc., has been a formidable problem since the inception of heavier-than-air flight. Ice adds weight, increases drag and alters the aerodynamic contour of airfoils, control surfaces and inlets, all of which reduce performance and consequently increase the specific filet consumption (SFC) of a gas turbine engine. In addition, ice permitted to form on aircraft structures can become dislodged and impact other aircraft parts and engine components, causing significant structural damage. For example, fragments of ice can break loose from the engine inlet and could severely damage rotating fan blades and other internal engine components. In severe instances, the damage that results from ice fragment impacts may lead to engine stall and could even cause engine failure. Accordingly, significant effort has been expended to address the problems associated with aircraft icing. Due to the aforementioned impact damage, particular attention has been directed to the inlet area of nacelles for gas turbine engines, commonly referred to as the “engine inlet” or “nacelle inlet.”

Typically, icing protection is provided by heating the areas of the aircraft that are prone to icing. One of the most common anti-icing techniques is to disperse hot bleed air gases from the engine, and in particular compressor bleed air from a gas turbine engine, over potential icing areas via a conduit extending from the compressor. For example, a portion of the hot air from the compressor of the gas turbine engine is extracted and directed through a bleed air duct to the D-duct area within the nacelle inlet to heat the thin walls of the nose cowling by convection heat transfer. The spent air is then discharged overboard via exhaust ports through slots formed in the D-duct. An anti-icing system and method of this type is well known and described in greater detail in, for example, U.S. Pat. No. 3,933,327 to Cook et al. (assigned to Rohr Industries, Inc. of Chula Vista, Calif.) and U.S. Pat. No. 4,738,416 to Birbragher (assigned to Quiet Nacelle Corporation of Miami, Fla.).

Simply delivering the heated air to the nacelle inlet, however, does not allow for sufficient heat energy to be extracted from the compressor bleed air prior to the spent air being exhausted overboard. Thus, it is commonly known to circulate the compressor bleed air within the leading edge of the nacelle inlet along the smooth inner walls of the D-duct. In a particular system and method described in U.S. Pat. No. 4,688,745 to Rosenthal (assigned to Rohr Industries, Inc. of Chula Vista, Calif.), entitled “Swirl Anti-Ice System,” the compressor bleed air is circulated in a swirling, rotational manner before the bleed air is exhausted overboard. The Rosenthal system and method directs hot gas from a high-pressure compressor section of a jet engine to the interior of the D-duct of the nacelle inlet through a conduit that enters the annular D-duct across the inlet forward bulkhead. The conduit is then turned through an angle of about 90 degrees relative to a direction that is tangential to the center-line of the leading edge annulus. The hot gas exits an injection nozzle provided at the outlet of the conduit and swirls around the interior of the D-duct. The swirling mass of bleed air transfers heat to the leading edge to prevent formation of ice on the lip of the nacelle inlet.

A further improvement to icing protection systems and methods is made by enhancing mixing of the hot gas with the mass of swirling air, as described in U.S. Pat. No. 6,354,538 to Chilukari (assigned to Rohr, Inc. of Chula Vista, Calif.). In the Chilukari anti-icing system, the injection nozzle at the outlet of the conduit is provided with a plurality of circumferentially-arranged, triangularly-shaped tabs that extend in an aft direction and are canted inwardly into the exiting flow of hot air. The tabs on the nozzle create large scale longitudinal vortices and turbulent flow in the hot air during injection so that the hot air mixes more rapidly and evenly with the larger mass of lower velocity air within the interior of the D-duct. As a result, the tabbed injection nozzle enhances mixing and entrainment of the hot air with the ambient air of the D-duct, while precluding the tendency for the formation of an area of elevated temperature downstream of the nozzle. Although use of this modified injection nozzle increases mixing of the compressor bleed air and thereby enhances heat transfer to the exterior surfaces of the D-duct, there is still a need to extract more of the heat energy from the bleed air directed to the nacelle inlet before the spent bleed air is discharged overboard through the exhaust slots of the D-duct.

U.S. Pat. No. 6,227,800 to Spring et al. (assigned to General Electric Company of Cincinnati, Ohio) describes providing a gas turbine engine with a series of “turbulators” that extend radially outward from the outer surface of the turbine casing. The axially-spaced turbulators act as heat dissipating fins to remove heat from the interior of the turbine casing, thereby locally increasing the heat transfer and convection cooling efficiency of bay air traveling through a cooling duct adjacent to the engine nozzle vanes and rotor blade shrouds. However, since the turbulators act as heat dissipating fins, it is necessary that they have a relatively large surface area within the cooling duct and are positioned immediately opposite the structural supports for the nozzle vanes and rotor blade shrouds. Accordingly, it is impractical to utilize turbulators of the type disclosed by Spring et al. to enhance heat transfer to the exterior surface of an aircraft structure that is susceptible to icing.

It is also known to augment heat transfer by coating a metallic substrate, and in particular an internal component of a gas turbine engine, with an outer metallic layer. As shown and described in U.S. Pat. No. 6,254,997 to Rettig et al. (assigned to General Electric Company of Cincinnati, Ohio), the outer metallic layer is deposited on and bonded with the substrate using an electric arc thermal spray deposition process so as to produce a coating on the exterior surface having a roughness of at least about 12.7 microns (500 micro-inches) Ra. The outer metallic layer has a relatively high coefficient of thermal conductivity and provides an increased amount of surface area in contact with the available volume of cooling air in order to augment heat transfer from the internal component of the gas turbine engine to the cooling air. Use of such an outer metallic layer coated onto a substrate by an electric arc thermal spray deposition process, however, has been limited to date for the purpose of augmenting heat transfer to remove heat from an internal component of a gas turbine engine operating at high temperatures.

Accordingly, there exists a need for an improved icing protection system for preventing the formation of ice on aircraft structures that are susceptible to icing. A need also exists for an improved method for enhancing heat transfer in aircraft structures that are susceptible to icing.

There exists a further and more specific need for an icing protection system and method for enhancing heat transfer that increases the amount of surface area exposed to an available volume of compressor bleed air directed onto an interior surface of an aircraft structure that is susceptible to icing.

### BRIEF DESCRIPTION OF THE INVENTION

The above mentioned needs and others that will be readily apparent to those skilled in the art are met by the invention, which in one aspect provides an icing protection system for preventing the formation of ice on a surface that is susceptible to icing. The icing protection system includes a substrate having a first outer surface, a second inner surface opposite the first surface and a thickness separating the first surface and the second surface. The icing protection system further includes a metallic layer deposited on the inner surface of the substrate. The metallic layer is operable for enhancing heat transfer from the compressor bleed air in flow contact with the metallic layer through the thickness of the substrate to prevent the formation of ice on the outer surface.

According to another aspect, the invention provides a method for enhancing heat transfer to a surface that is susceptible to icing. The method includes providing a substrate having a first outer surface, a second inner surface opposite the first surface, and a thickness separating the first surface and the second surface. The method further includes depositing a metallic layer on the inner surface and dispersing a heated gas in flow communication with the metallic layer to enhance heat transfer from the heated gas through the thickness of the substrate and thereby prevent the formation of ice on the outer surface.

According to another aspect, the invention provides an icing protection system for preventing the formation of ice on an aircraft structure that is susceptible to icing and for enhancing heat transfer in the aircraft structure. The icing protection system includes a substrate having an inner surface, an outer surface opposite the inner surface and a thickness separating the inner surface and the outer surface. The icing protection system further includes a metallic layer deposited on the inner surface by an electric arc thermal spray deposition process. The metallic layer defines a plurality of micro-fins operable for enhancing heat transfer from a heated gas in flow communication with the metallic layer through the thickness of the substrate to prevent the formation of ice on the outer surface.

According to another aspect of the invention, the substrate is a D-duct defined by a nacelle inlet, the inner surface is the inner wall of the D-duct and the outer surface is the outer wall of the D-duct.

According to another aspect of the invention, the electric arc thermal spray deposition process uses at least one metallic wire for depositing the metallic layer and the metallic layer has a thickness in the range of about 0.203 mm (0.008 inches) to about 0.432 mm (0.017 inches), a surface roughness greater than about 12.7 microns (500 micro-inches) Ra, a heat transfer augmentation of from about 1.1 to 1.5, and a heat transfer surface area enhancement from about 1.1 to 1.8.

According to another aspect of the invention, at least a portion of the metallic layer is an M-Cr—Al alloy and M is at least one element selected from the group consisting of Fe, Co and Ni.

### BRIEF DESCRIPTION OF THE DRAWINGS

Several aspects of the invention have been set forth above. Other aspects will be readily apparent to one skilled in the art when the following detailed description of the invention is considered in conjunction with the accompanying drawings.

FIG. 1 is a partially sectioned elevation view of a gas turbine aircraft engine including a D-duct defined by a nacelle inlet and a compressor bleed air duct extending between the compressor and the D-duct.

FIG. 2 is a sectioned view of the nacelle inlet of the gas turbine aircraft engine of FIG. 1.

FIG. 3 is a detailed sectioned view of a portion of the D-duct defined by the nacelle inlet taken from FIG. 2, showing turbulators or micro-fins formed on the inner wall of the D-duct.

FIG. 4 is an enlarged sectioned view taken from FIG. 3 showing the turbulators or micro-fins formed on the inner wall of the D-duct in greater detail.

FIG. 5 is a graph depicting surface area ratio, fin efficiency and heat transfer augmentation as a function of the thickness of a coating of a metallic layer for enhancing heat transfer.

FIG. 6 is a graph depicting heat transfer augmentation for a high Reynolds Number and a low Reynolds Number application as a function of the thickness of a coating of a metallic layer for enhancing heat transfer.

### DETAILED DESCRIPTION OF THE INVENTION

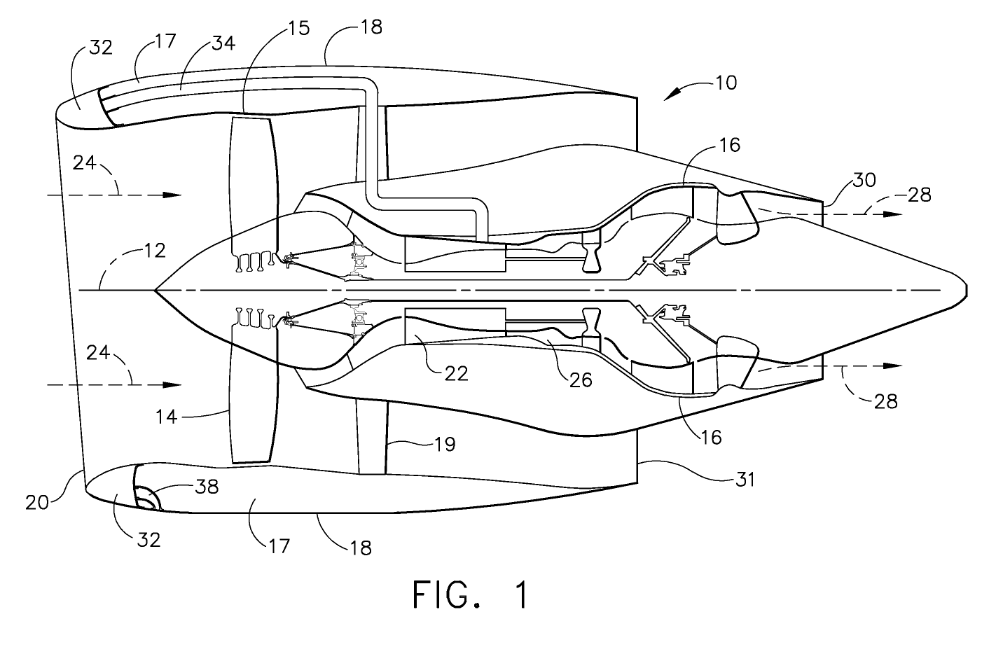

Referring to the drawings in which identical reference numerals denote the same elements throughout the various views, FIG. 1 illustrates schematically a gas turbine engine, indicated generally at 10, of the type typically utilized to power modern aircraft. The engine 10 is symmetrical about a longitudinal axis 12 and includes a fan 14 powered by a core engine 16. The fan 14 includes a plurality of fan blades rotatably mounted within an annular fan casing 15 that surrounds the fan and at least a portion of the core engine 16. The “engine inlet” or “nacelle inlet” 20 of the engine 10 is mounted to the forward flange of the fan casing 15. The core engine 16 includes a multistage compressor 22 having sequential stages of stator vanes and/or rotor blades that pressurize an incoming flow of air 24. The pressurized air discharged from the compressor 22 is mixed with fuel in the combustor 26 of the core engine 16 to generate hot combustion gases 28 that flow downstream through one or more turbines, such as a high-pressure turbine (HPT) and a low-pressure turbine (LPT). The HPT and LPT extract energy from the combustion gases 28 prior to the gases being discharged from the outlet end 30 of the engine 10. The HPT powers the compressor 22 of the core engine 16, and the LPT powers the fan 14.

The nacelle inlet 20 defines a generally annular D-duct 32 adjacent to the leading edge, and the fan compartment 17 houses a conduit 34 extending between the compressor 22 and the D-duct 32 for delivering compressor bleed air to the D-duct. Accordingly, the conduit 34 is commonly referred to as the “bleed air duct.” The majority of the incoming flow of air 24 pressurized by the fan 14 is bypassed through the outlet guide vanes (OGVs) 19 and discharged at the outlet end 31 of the fan bypass duct of the engine 10 to provide propulsive thrust for powering the aircraft. The remaining incoming flow of air 24 is directed through the radially innermost portion of the fan 14 into the core engine 16 to be pressurized within the various stages of the compressor 22 and utilized in the combustion process, or as bleed air. As such, the engine 10 typically includes a bleed system for bleeding pressurized air from the compressor 22 during engine operation for subsequent use in the aircraft. The bleed system includes a primary bleed circuit comprising various conduits and valves for directing the pressurized air from the compressor 22 to different parts of the aircraft. With regard to the present invention, the bleed system directs a portion of the pressurized air from the compressor 22 into the bleed air duct 34 to deliver bleed air at high pressure and temperature to the D-duct 32 of the nacelle inlet 20.

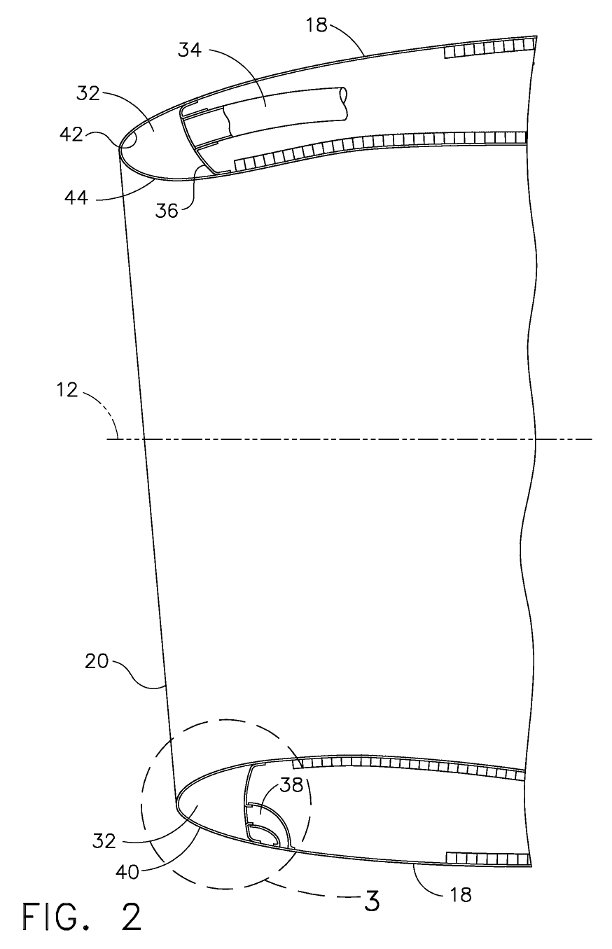

As best shown in the sectioned view FIG. 2, D-duct 32 extends circumferentially around the leading edge of the nacelle inlet 20. Bleed air duct 34 delivers the bleed air from the compressor 22 through an opening formed in an annular bulkhead 36 so that the heated gas from the compressor mixes with and entrains the ambient air within the D-duct 32. The high temperature and pressure of the heated gas from the compressor 22 causes the resulting mass of air to swirl and flow circumferentially around the D-duct 32 to one or more exhaust ports 38, where it is discharged overboard through an exterior opening formed in the inlet outer barrel 18 of the fan casing 15. As the heated gas is circulated around the D-duct 32, the thermal energy of the heated gas is dissipated by combined convection and conduction heat transfer through the relatively thin wall 40 of the nacelle inlet 20. The wall 40 of the nacelle inlet 20 has an interior, or inner, surface 42 and an exterior, or outer, surface 44 separated by a thickness. The inner surface 42 is in flow communication with the mass of air circulating around the D-duct 32 and transfers a portion of the thermal energy of the heated gas through the thickness of the wall 40 to the outer surface 44, thereby preventing the formation of ice on the outer surface. The amount of heat transfer, however, is dependent upon the initial temperature of the heated gas, the rate at which the mass of air flows around the D-duct 32 before being exhausted overboard through the exhaust port 38, and the surface treatment of the wall 40. The temperature of the heated gas is limited in certain instances by engine operating conditions. The thickness of the wall 40 of the nacelle inlet 20 is limited by design considerations, such as buckling strength, fatigue and shear strength.

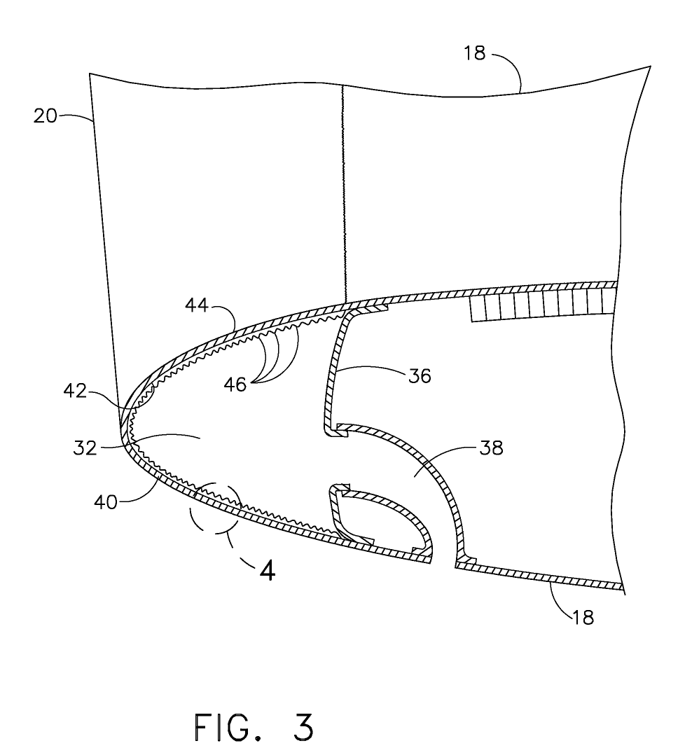

FIG. 3 is a detailed sectioned view of a portion of the D-duct 32 defined by the nacelle inlet 20. As shown, turbulators 46 are formed on the inner surface (also referred to herein as the inner wall) 42 of the wall 40 for enhancing heat transfer through the thickness of the wall to the outer surface (also referred to herein as the outer wall) 44. The turbulators 46 act to increase the exposed surface area of the inner wall 42 in flow communication with the heated gas circulating within the D-duct 32. The turbulators 46 increase the exposed surface area of the inner wall 42 by as much as from 10% to 80%, depending on the height of the micro-fins used. In addition, the turbulators 46 increase the convective heat transfer coefficient on the inner wall 42 by as much as from 10% to 50%, also depending on the height of the micro-fins used, The combined increase in heat transfer coefficient and exposed surface area for heat transfer on the inner wall thereby augment heat transfer of the thermal energy of the heated gas to the outer wall 44.

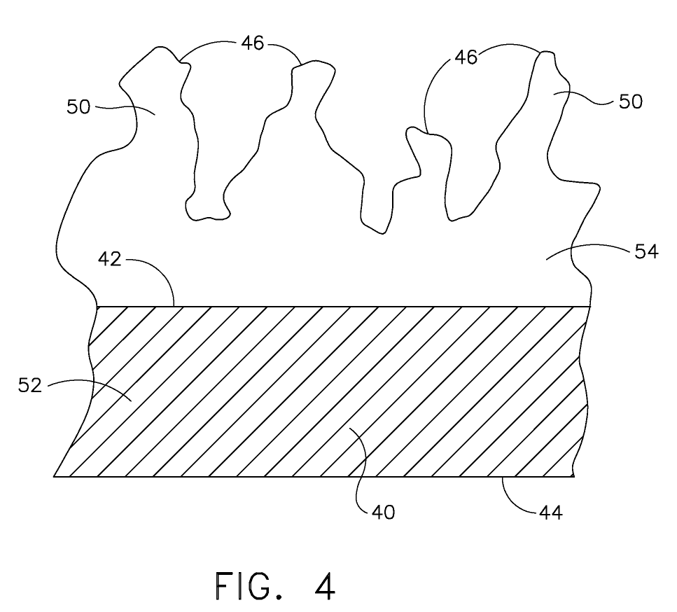

FIG. 4 is an enlarged sectioned view showing the turbulators 46 formed on the inner wall 42 of the D-duct 32 in greater detail. The turbulators 46 define relatively thin, irregularly-shaped “micro-fins” 50 configured to absorb and conduct thermal energy from the heated gas to the outer wall 44 of the D-duct 32 by conduction across the thickness of the wall 40 when the micro-fins are in flow communication with the mass of air circulating within the D-duct. The micro-fins 50 may be formed on the inner wall 42 of the D-duct 32 by any suitable process. In a particularly advantageous embodiment, however, the micro-fins 50 are formed on the inner wall 42 of the wall 40 by depositing a relatively thin metallic coating that bonds to the metal substrate 52 of the wall 40 to form a metallic layer 54 of the micro-fins on the surface of the inner wall. The metallic layer 54 is preferably deposited on the substrate 52 by an electric arc thermal spray deposition process using at least one metallic wire that can deposit a relatively rough layer of the micro-fins 50 onto the inner wall 42. Generally, in electric arc wire spraying, at least two wires of the same, similar or different materials are melted by an electric arc, atomized into molten particles, and the molten particles are propelled by a high velocity stream of gas, such as of an inert or reducing gas or air, onto the surface of a substrate to bond with the surface and to each other, thereby building a coating or layer of the wire material. The surface of the substrate may be prepared by grit blasting to enhance surface bonding of the molten particle droplets propelled by the stream of gas in the electric arc wire spray process. The parameters of the electric arc thermal spray deposition process can be readily adjusted to provide the desired fin height, thickness and roughness characteristics of a metallic layer 54 required for a particular application.

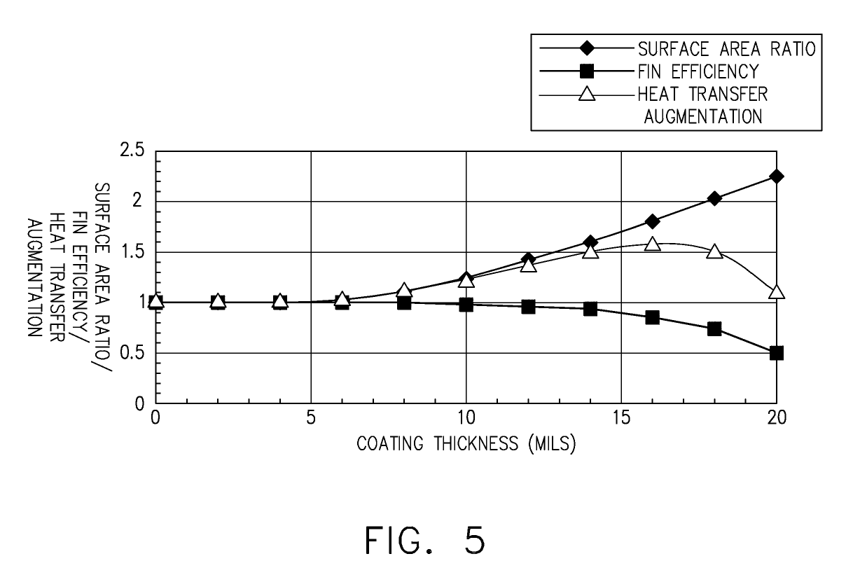

In general, the roughness of the metallic layer 54 increases with the thickness of the metallic coating applied to the inner wall 42. As the micro-fin height increases beyond a certain limit and the fin efficiency starts to drop, the heat transfer augmentation also drops in concert. This effect is illustrated by the graph of FIG. 5, in which the metallic layer 54 is deposited as a coating, comparing surface area ratio (the ratio of rough coated surface area to smooth uncoated surface area), fin efficiency, and heat transfer augmentation with coating thickness. It should be noted in FIG. 5 that the actual heat transfer augmentation declines after a coating thickness of about 0.432 mm (0.017 inches). Of course, in the absence of any coating of metallic layer 54 the values of each of the variables plotted along the vertical axis would be equal to 1.0.

Suitable embodiments of wall 40 and metallic layer 54 includes substrates 52 made of high temperature nickel-based and cobalt-based super alloys, commercially available as IN 718 alloy and HS 188 alloy, that have been electric arc thermal sprayed with a high temperature metallic coating representative of and selected from a group of coatings based on Fe, Co or Ni, or their combinations. Such coating alloys are commonly referred to as the M-Cr—Al alloys in which the M is Fe, Co, Ni, or their combination. A particularly advantageous metallic coating comprises a Ni—Cr—Al—Y type alloy consisting nominally by weight of 21.5% Cr, 10% Al, 1% Y, with the balance Ni. Being metallic, this coating material inherently has a relatively high coefficient of thermal conductivity as compared with non-metallic coatings. The heat transfer augmentation of such a metallic layer 54 to the substrate 52, however, depends primarily on conditions of surface roughness and coating thickness.

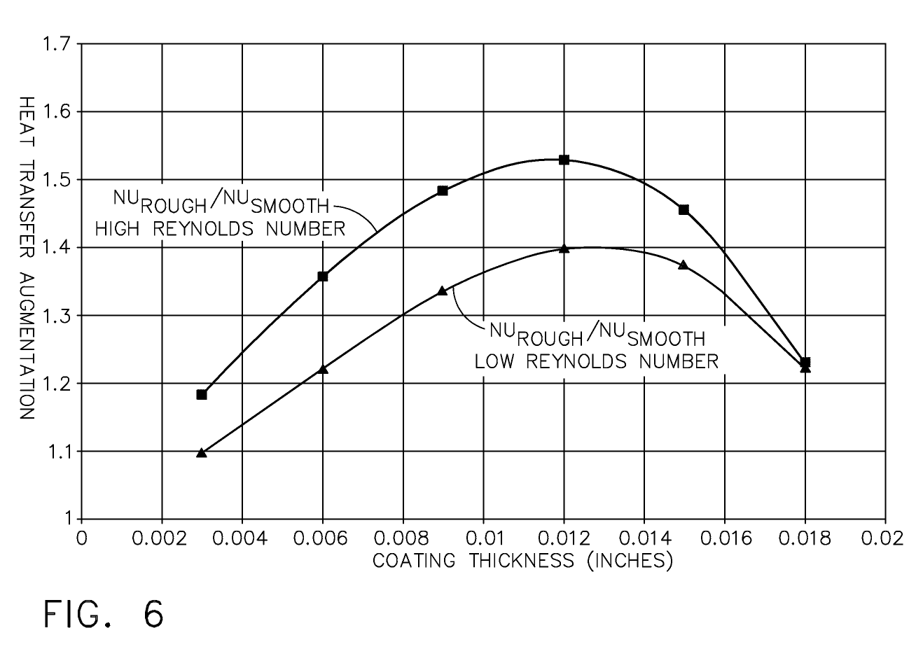

FIG. 6 summarizes the heat transfer augmentation of the above-described metallic layer for NUrough/NUsmooth at a range of Reynolds numbers. NUrough/NUsmooth, as used herein, means the ratio of Nusselt number calculated for a roughened surface to Nusselt number calculated for a smooth surface, the ratio representing heat transfer augmentation. From this example, which generated the data represented in FIG. 6, in order to attain a heat transfer augmentation of at least about 1.3 to 1.5, the average coating thickness must be at least about 0.203 mm (0.008 inches), but less than about 0.432 mm (0.017 inches). At the same time, in order to attain a heat transfer augmentation of at least about 1.3 to 1.5, the average surface roughness (Ra) of the metallic layer 54 deposited on the inner wall 42 must be greater than about 29.97 microns (1180 micro-inches) Ra up to about 43.18 microns (1700 micro-inches) Ra. However, a heat transfer augmentation of about 1.1 can be achieved at a coating roughness of only about 12.7 microns (500 micro-inches) Ra. The average surface roughness (Ra) of the metallic coating as determined herein can be obtained from measurements made with a skidded contact profilometer using a stroke cut-off length of 2.54 mm (0.100 inches). The thickness of the metallic coating can be determined using a 6.35 mm (0.250 inches) diameter flat anvil micrometer. According to a preferred form of the invention, a metallic layer 54 for augmentation of heat transfer to a substrate 52 is characterized by a relatively high coefficient of thermal expansion and a thickness in the range of about 0.203-0.432 mm (0.008-0.017 inches), in combination with an average surface roughness of greater than about 12.7 microns (500 micro-inches) Ra, and preferably up to about 43.18 microns (1700 micro-inches) Ra.

A metallic layer 54 suitable for use with an icing protection system and method according to the present invention is preferably applied in the form of a relatively thin coating by an electric arc thermal spray deposition process using at least one metallic wire consisting of a Ni—Cr—Al—Y type alloy that is deposited on and bonded with the metal substrate 52 of the wall 40 on the inner wall 42 of the nacelle inlet 20. In a preferred form, the metallic layer 54 has a total coating thickness in the range of from about 0.203 mm (0.008 inches) up to about 0.432 mm (0.017 inches), taken as an average of the total thicknesses measured at various locations on the inner wall 42. Metallic layer 54 preferably has a surface roughness portion of at least about 12.7 microns (500 micro-inches) Ra, and preferably between about 30.48-43.18 microns (1200-1700 micro-inches) Ra. The balance of the metallic layer 54 is an inner portion, which together with roughness portion defines the entire thickness of the coating. As the thickness of the inner portion increases, it tends to resist heat transfer to substrate 52. Therefore, the inner portion of metallic layer 54 being thicker than necessary is undesirable. With a surface roughness of at least about 12.7 microns (500 micro-inches) Ra, and preferably at least about 29.97 microns (1180 micro-inches) Ra, increasing the thickness of inner portion of the metallic layer 54 such that the total thickness of the metallic layer is greater than about 0.432 mm (0.017 inches) can reduce the rate of heat transfer from the heated gas to the substrate 52. Further examples of a metallic layer 54 suitable for use with the invention, as well as the electric arc thermal spray deposition process parameters suitable for forming such a metallic layer, are disclosed in the aforementioned U.S. Pat. No. 6,254,997 to Rettig et al., the disclosure of which is hereby incorporated in its entirely.

As shown and described in this detailed description of the invention and its best mode of practice, the substrate 52 is the wall 40 of the D-duct 32 of the nacelle inlet 20 of a gas turbine engine 10, and the surface on which the metallic layer 54 is deposited is the inner wall 42. However, the substrate 52 may be any aircraft structure that is susceptible to icing. By way of example and without limitation, the substrate 52 may be any aircraft structure such as an engine inlet wing, control surface, propeller, booster inlet vane, inlet frame, etc. having a smooth inner wall that is utilized as a convective surface for heat transfer to an outer wall susceptible to icing. In a broad sense, the invention is the application of a plurality of turbulators that act as micro-fins to the smooth inner wall to enhance heat transfer through the wall to an outer surface that is susceptible to icing.

In preferred embodiments, the invention combines heat transfer augmentation of at least about 1.1, and more preferably as high as about 1.5, with an increase in heat transfer surface area of at least about fifty percent (50%). The invention permits a reduction of the compressor bleed air mass flow rate required for icing protection, as compared to conventional icing protection systems. Alternatively, the invention permits a reduction of the compressor bleed air temperature required for an icing protection system, and hence, the use of a lower High Pressure Compressor (HPC) stage for extraction of the bleed air. All of which contribute to a significant improvement in Specific Fuel Consumption (SPC) and/or rate of fuel burn for a modern aircraft operating a gas turbine engine.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

That which is claimed:

1. An icing protection system for preventing the formation of ice on a surface that is susceptible to icing, the system comprising:
a substrate having a first surface, a second surface opposite the first surface and a thickness separating the first surface and the second surface; and
a metallic layer deposited on the first surface of the substrate, the metallic layer operable for enhancing heat transfer from a heated gas in flow communication with the metallic layer through the thickness of the substrate to prevent the formation of ice on the second surface.

2. The icing protection system of claim 1, wherein the first surface is the inner surface of an aircraft structure and the second surface is the outer surface of the aircraft structure.

3. The icing protection system of claim 1, wherein the metallic layer is deposited on the first surface of the substrate by an electric arc thermal spray deposition process using at least one metallic wire.

4. The icing protection system of claim 3, wherein the metallic layer has a thickness in the range of about 0.203 mm (0.008 inches) to about 0.432 mm (0.017 inches) and a surface roughness greater than about 12.7 microns (500 micro-inches) Ra.

5. The icing protection system of claim 3, wherein the metallic layer has a heat transfer augmentation of at least about 1.1.

6. The icing protection system of claim 3, wherein at least a portion of the metallic layer comprises an M-Cr—Al alloy and M is at least one element selected from the group consisting of Fe, Co and Ni.

7. The icing protection system of claim 1, wherein at least a portion of the metallic layer deposited on the first surface of the substrate defines a plurality of micro-fins for enhancing heat transfer from the heated gas to the second surface.

8. The icing protection system of claim 1, wherein the substrate comprises a D-duct defined by a nacelle inlet, the first surface is the inner wall of the D-duct and the second surface is the outer wall of the D-duct, and wherein at least a portion of the metallic layer defines a plurality of micro-fins deposited on the inner wall of the D-duct by an electric arc thermal spray deposition process using at least one metallic wire.

9. A method for enhancing heat transfer to a surface that is susceptible to icing, the method comprising:
providing a substrate having a first surface, a second surface opposite the first surface, and a thickness separating the first surface and the second surface; and
depositing a metallic layer on the first surface; and
disposing a heated gas in flow communication with the metallic layer to enhance heat transfer from the heated gas through the thickness of the substrate and thereby prevent the formation of ice on the second surface.

10. The method of claim 9, wherein the first surface is the inner surface of an aircraft structure and the second surface is the outer surface of the aircraft structure.

11. The method of claim 9, wherein the metallic layer is deposited on the first surface of the substrate by an electric arc thermal spray process using at least one metallic wire.

12. The method of claim 11, wherein the metallic layer has a thickness in the range of about 0.203 mm (0.008 inches) to about 0.432 mm (0.017 inches) and a surface roughness greater than about 12.7 microns (500 micro-inches) Ra.

13. The method of claim 11, wherein the metallic layer has a heat transfer augmentation of at least about 1.1.

14. The method of claim 11, wherein at least a portion of the metallic layer comprises an M-Cr—Al alloy and M is at least one element selected from the group consisting of Fe, Co and Ni.

15. The method of claim 9, wherein at least a portion of the metallic layer deposited on the first surface of the substrate defines a plurality of micro-fins for enhancing heat transfer from the heated gas to the second surface.

16. The method of claim 9, wherein the substrate comprises a D-duct defined by a nacelle inlet, the first surface is the inner wall of the D-duct and the second surface is the outer wall of the D-duct, and wherein at least a portion of the metallic layer defines a plurality of micro-fins deposited on the inner wall of the D-duct by an electric arc thermal spray deposition process using at least one metallic wire.

17. An icing protection system for preventing the formation of ice on an aircraft structure that is susceptible to icing and for enhancing heat transfer in the aircraft structure, the system comprising:
a substrate having an inner surface, an outer surface opposite the inner surface and a thickness separating the inner surface and the outer surface;
a metallic layer deposited on the inner surface by an electric arc thermal spray deposition process, the metallic layer defining a plurality of micro-fins operable for enhancing heat transfer from a heated gas in flow communication with the metallic layer through the thickness of the substrate to prevent the formation of ice on the outer surface.

18. The icing protection system of claim 17, wherein the substrate comprises a D-duct defined by a nacelle inlet, the inner surface is the inner wall of the D-duct and the outer surface is the outer wall of the D-duct.

19. The icing protection system of claim 17, wherein the electric arc thermal spray deposition process uses at least one metallic wire, and wherein the metallic layer has a thickness in the range of about 0.203 mm (0.008 inches) to about 0.432 mm (0.017 inches), a surface roughness greater than about 12.7 microns (500 micro-inches) Ra, and a heat transfer augmentation of at least about 1.1.

20. The icing protection system of claim 17, wherein at least a portion of the metallic layer comprises an M-Cr—Al alloy and M is at least one element selected from the group consisting of Fe, Co and Ni.
